(19) United States
(12) Patent Application Publication
(10) Pub. No.: US 2026/0106199 A1
(43) Pub. Date: Apr. 16, 2026

(54) DEVICE AND METHOD FOR GENERATING AN ELECTRODE STACK WITH FLAT ELECTRODE ELEMENTS

(71) Applicant: GIESECKE+DEVRIENT CURRENCY TECHNOLOGY GMBH, Munchen (DE)

(72) Inventors: Xaver THUM, Wolfratshausen (DE); Frank NEUDEL, Freising (DE)

(21) Appl. No.: 19/116,613

(22) PCT Filed: Sep. 27, 2023
(86) PCT No.: PCT/DE2023/100718

§ 371 Date: Mar. 28, 2025

(30) Foreign Application Priority Data
Sep. 30, 2022 (DE) 10 2022 125 359.7

(51) Int. Cl. H01M 10/04

(52) U.S. Cl. CPC H01M 10/0404

(57) ABSTRACT

A device for producing an electrode stack containing flat electrode elements includes a stacking wheel, which is mounted to rotate about a stacking wheel axis and has a plurality of stacking wheel fingers, which define respective intermediate spaces for receiving the electrode elements, and a wiper unit, which is designed to remove the electrode elements one after the other from the respective intermediate spaces through interaction with a rotational movement of the stacking wheel about the stacking wheel axis. The device furthermore includes a receiving unit for successively receiving the electrode elements removed from the intermediate spaces. The receiving unit has a base structure, on which the electrode elements received in the receiving unit can be stacked, and a delimiting element, which forms an end stop for the electrode elements received in the receiving unit and which is arranged statically in relation to the stacking wheel axis.

This invention relates to the stacking of electrode elements for manufacturing energy stores or energy converters. In particular, this invention relates to a device for producing an electrode stack containing flat electrode elements and to a method for producing an electrode stack containing flat electrode elements.

The stacking of flat electrode elements is known. As such, electrode elements for manufacturing electrochemical energy stores, such as lithium ion batteries, or energy converters, such as fuel cells, are usually stacked. In particular when manufacturing pouch cells, a widely used design of a lithium ion rechargeable battery, electrode elements are stacked. The electrode elements in this case are usually in the form of a cathode, based for example on aluminum foil, and an anode, based for example on copper foil. The smallest unit of any lithium ion cell consists of two electrodes and a separator, which separates the electrodes from one another. Later, after filling, there is the ion-conductive electrolyte in between. The stacking process involves the electrode elements being stacked in a repeating cycle of anode, separator, cathode, separator, and so on.

Currently known systems for stacking the electrode elements sometimes lack precision for stacking the individual electrode elements above one another, however, which can lead to impairments in the efficiency and possibly even in the functioning of the energy store that is ultimately manufactured. In particular, positional deviations in the object current of the electrode elements fed to the stack can arise, which makes it difficult to stack the electrode elements in alignment.

The object of this invention is to improve the positional accuracy of individual electrode elements when forming an electrode stack.

This object is achieved by the subject matter of the independent claims. Illustrative embodiments can be obtained from the dependent claims and the description that follows.

According to one aspect, a device for producing an electrode stack containing flat electrode elements is specified. The device comprises a stacking wheel, which is mounted to rotate about a stacking wheel axis and has a plurality of stacking wheel fingers, which define respective intermediate spaces for receiving the electrode elements. The device furthermore comprises a wiper unit, which is designed to remove the electrode elements one after the other from the respective intermediate spaces through interaction with a rotational movement of the stacking wheel about the stacking wheel axis. The device furthermore comprises a receiving unit, which is designed to successively receive the electrode elements removed from the intermediate spaces. The receiving unit comprises a base structure, on which the electrode elements received in the receiving unit can be stacked, and a delimiting element, which forms an end stop for the electrode elements received in the receiving unit and which is arranged statically in relation to the stacking wheel axis.

The inventive device can be used to ensure exact alignment of the electrode elements stacked in the receiving unit, as the static delimiting element always has the same position and/or alignment in relation to the electrode elements conveyed into the receiving unit. The delimiting element therefore prevents, among other things, electrode elements already placed or stacked in the receiving unit from being able to slip through other electrode elements conveyed into the receiving unit, for example on account of a pushing or thrusting movement. In other words, the delimiting element allows the end stop adjusted for a width or length of the electrode elements to halt the electrode elements introduced into the receiving unit, in some cases at high speed, toward the outside. The underlying electrode elements already stacked are therefore prevented from being displaced outside when a new electrode element is put on and introduces a force in a pushing manner.

Similarly, the static arrangement of the delimiting element in relation to the stacking wheel axis can compensate for individual electrode elements being misaligned when transported by the stacking wheel, which would otherwise lead to the electrode elements potentially not being stacked in alignment in the receiving unit. In other words, even if individual electrode elements are misaligned or in different positions when transported by the stacking wheel, the delimiting element can provide a fixed end stop that ensures that the electrode elements are stacked above one another exactly and thus in alignment.

Alternatively or additionally, the delimiting element may be arranged statically in relation to the base structure, that is to say the stacking base.

In this context, the term “statically” can mean that the delimiting element cannot move in relation to the stacking wheel axis, but rather is fixed in relation thereto. In particular, this may mean that the delimiting element also cannot be moved with respect to the stacking wheel axis after an electrode stack is formed. This allows the provision of a high level of reproducibility with high positional quality and positional accuracy for the stacked electrode elements across multiple different stacks, which would not be possible in this way if the delimiting element were to be displaced with respect to the stacking wheel axis. It is thus possible to ensure that every electrode element entering the receiving unit and stacked is introduced into the receiving unit by the same maximum distance.

According to one advantageous embodiment, the delimiting unit can be moved to configure the device outside of normal operation, in particular in a configuration mode, and in particular when the receiving unit is empty. This allows the device to be adjusted for elements in other formats, or to compensate for any partial turn-up that occurs at the outer edge, which in particular corresponds to a separator. The turn-up, which sticks up on the delimiting element, can lead to an element that has just been put on now being in contact not with the boundary, but rather with the turn-up of the underlying cell.

The flat electrode elements are stacked for example as electrode elements for manufacturing electrochemical energy stores, such as lithium ion batteries, or energy converters, such as fuel cells. In particular, the electrode stack provided by the inventive device can be used as a basis for manufacturing such energy stores or energy converters.

The electrode elements may be in the form of a cathode and/or an anode. In particular, the cathode and the anode are conveyed alternately. A separator or separating layer can be arranged between the electrode elements, in particular between the cathode and the anode. The stacking process can thus involve the electrode elements being stacked in a repeating cycle, alternately stacking an anode, a separator, a cathode, a separator, and so on.

Alternatively, the electrode elements may also already be in the form of a prefabricated cell that comprises a cathode, an anode and preferably also at least one separating layer. The electrode element may already be in the form of a cell, and finished cells can be stacked on top of one another in the receiving unit.

The stacking wheel can be a rotating unit. The stacking wheel fingers, which can stretch substantially radially in relation to the stacking wheel axis of the stacking wheel, define multiple intermediate spaces, which may each be separated from one another by the stacking wheel fingers in the circumferential direction of the stacking wheel.

For example, a first intermediate space may be defined by a first row of stacking wheel fingers and by a second row of stacking wheel fingers. Adjacent intermediate spaces may in turn be separated from one another by such rows of stacking wheel fingers.

The intermediate spaces can receive the electrode elements, there being able to be provision for an individual intermediate space to be designed to receive one electrode element. In particular, there may be provision for a feed unit to introduce or push an electrode element into an intermediate space of the stacking wheel, this electrode element subsequently being transported by the rotation of the stacking wheel into the region of the receiving unit. There, the electrode element can then be conveyed out of the intermediate space and into the receiving unit by the wiper unit or a wiper. The wiper unit may be fixed in the device together with the stacking wheel axis or the axis of rotation of the stacking wheel, with the result that the rotational movement of the stacking wheel causes the electrode element to be pushed out of the intermediate space through interaction with the wiper unit.

The rotational movement of the stacking wheel about the stacking wheel axis and the filling of the plurality of intermediate spaces distributed in the circumferential direction of the stacking wheel with one electrode element each allows a sequence of successive electrode elements to be conveyed into the receiving unit, said electrode elements subsequently being stacked there to form an electrode stack.

While the electrode elements are being fed into the receiving unit, they can follow a sequence of movements or pattern of movements. The end of each movement of the electrode elements can come from their striking against the delimiting element. In other words, the movement of the electrode elements received in the receiving unit can be stopped by the delimiting element, in particular by their hitting the delimiting element. This can apply equally to every electrode element received in the receiving unit, and so every electrode element is conveyed into the receiving unit by the same distance before it is stopped at the delimiting element, which in turn ensures exact alignment of the individual electrode elements with one another within the stack. The base structure can form a bearing surface for depositing the electrode stack. The base structure can be moved for example such that the bearing plane of each new element to be deposited is a static match for the stacking wheel and the delimiting element.

Thus, the term “end stop” can mean that the electrodes, on entering the receiving unit, strike against or hit the delimiting element at a specific speed. The delimiting element may therefore in particular differ from a pushing device, which would align the electrode elements only after they have been deposited in a stacked manner on the base structure. As already mentioned above, the effect achieved by the end stop is that individual electrode elements already deposited or stacked in the receiving unit can be displaced as a result of a bump from a subsequently stacked electrode element.

According to one embodiment, the delimiting element forms the end stop for the electrode elements received in the receiving unit in such a way that the electrode elements received in the receiving unit are prevented from moving in at least one direction so as therefore to permit the electrode elements to be stacked in alignment.

In particular, this can mean that electrode elements that are already stacked in the receiving unit and thus at rest are prevented from moving in the at least one direction. The delimiting element can therefore prevent individual, already stacked electrode elements from slipping or subsequently slipping, which could potentially still happen without the end stop formed by the delimiting element.

Preferably, the electrode elements are deposited, in particular regularly, in the same plane and this is achieved through the gradual lowering of the depositing base, in particular without the delimiting element being moved too.

The stacking wheel may be in single-or multi-element form.

The delimiting element may also be in single-or multi-element form.

According to one embodiment, the delimiting element is arranged statically in relation to the base structure in such a way that electrode elements stacked in the receiving unit are prevented from moving in a direction tangential to the rotational movement of the stacking wheel.

By way of example, the delimiting element is arranged within a direction of movement of the electrode elements conveyed into the receiving unit, with the result that the electrode elements, when conveyed into the receiving unit, bump against the delimiting element and are prevented from further movement. This can encompass stopping the electrode elements at the delimiting element.

The tangential direction to the rotational movement of the stacking wheel may be indicated for example by an imaginary tangent in relation to a circumferential direction of the stacking wheel. Accordingly, the tangential direction may also be a direction extending perpendicular to a radial direction of the stacking wheel.

According to one advantageous embodiment, a position of the delimiting element relative to a position of the base structure is fixed, with the result that a receiving expanse defined by the base structure is invariable.

In particular, the receiving expanse can correspond to a dimension between the delimiting element and an end stop (e.g. the wiper) arranged opposite the delimiting element (in relation to the electrode stack) along the base structure. The position of the delimiting element relative to the end stop (e.g. the wiper) arranged opposite the delimiting element is preferably fixed.

The receiving expanse can be a dimension along the base structure that forms a bearing region or a bearing surface for depositing the electrode stack. This receiving expanse can be kept continually constant by statically arranging, in particular permanently positioning, the delimiting element, with the result that all electrode elements conveyed into the receiving unit cover the same distance to the delimiting element before they bump against the delimiting element and come to rest. The delimiting element can thus be a boundary of the receiving expanse. An end stop, in particular the wiper, opposite the delimiting element can be a boundary of the receiving expanse that is opposite the delimiting element. There may be provision for not only the position of the delimiting element but also an alignment of the delimiting element relative to the stacking wheel axis to be fixed.

According to one embodiment, the receiving expanse defined by the base structure extends parallel to a direction arranged perpendicular to the stacking wheel axis.

That is to say that the receiving expanse can stretch along the base structure and can thus be measured along the tangential direction of the rotational movement of the stacking wheel outlined above. To put it another way, the receiving expanse can be measured for example in a direction extending perpendicular to the radial direction of the stacking wheel outlined above. The receiving unit can furthermore have lateral delimiters that prevent the stacked electrode elements from slipping in a direction parallel to the stacking wheel axis or axis of rotation of the stacking wheel.

According to one embodiment, the base structure is arranged displaceably with respect to the stacking wheel.

Here, the term “displaceably” can mean that the base structure can be displaced according to a translational movement. By way of example, this can mean that this does not involve a rotational movement of the base structure, in particular. The displacement of the base structure may be away from the stacking wheel, with the result that a spacing between the base structure of the receiving unit and the stacking wheel axis increases as the electrode stack grows.

According to one embodiment, the base structure is displaceable with respect to the stacking wheel on the basis of a present stack height of electrode elements and/or a present mass of electrode elements in the receiving unit.

That is to say that, the higher the electrode stack, the more the base structure can be displaced away from the stacking wheel axis. As the electrode stack grows, the spacing between the base structure and the stacking wheel axis can thus increase. Similarly, the displacement may be dependent on a total mass or a weight of the electrode elements stacked on the base structure. The displacement can be provided by passive means, for example a spring device, or by active means, for example a drive unit for moving the base structure. Such a drive unit will be outlined more precisely later on. After the electrode stack has been removed from the receiving unit for further processing, the base structure can be displaced back into an initial position in relation to the stacking wheel.

According to one embodiment, the base structure is displaceable with respect to the stacking wheel along a direction of displacement extending along or parallel to a radial direction of the stacking wheel.

The radial direction of the stacking wheel may be the radial direction already outlined above, for example. Displacement along the radial direction or parallel to the radial direction of the stacking wheel allows the spacing between the base structure and the stacking wheel axis to be varied during the displacement.

According to one embodiment, the stacking wheel, the wiper unit and the receiving unit are arranged in relation to one another in such a way that the electrode elements follow a specific sequence of movements when being removed from the intermediate spaces and when being received in the receiving unit, wherein the base structure is displaceable with respect to the stacking wheel in such a way that the sequence of movements is identical for every electrode element received in the receiving unit.

In particular, the base structure can be displaced or lowered with respect to the stacking wheel in such a way that an upper bearing surface formed by the respective most recently stacked electrode element always has the same spacing from the stacking wheel. The sequence of movements that is performed by an electrode element between its being removed from the respective intermediate space of the stacking wheel and its being deposited on the upper bearing surface of the most recently stacked electrode element can therefore be identical for every electrode element conveyed into the receiving unit. This preferably results in the same forces always acting on the respective most recently deposited electrode elements, which means that identical circumstances can be obtained for depositing each individual electrode element. This promotes, among other things, reproducibility and stack quality across multiple different electrode stacks.

According to one embodiment, the base structure is arranged displaceably with respect to the stacking wheel in such a way that a spacing between the stacking wheel axis and a respective electrode element most recently received in the receiving unit is constant.

As outlined above, this ensures that the sequence of movements is identical for every electrode element conveyed into the receiving unit, and in particular the depositing movement of the electrode element on the stack. For example motor-based tracking of the base structure allows all electrode elements to always be deposited on the stack at the same height. Electrode elements with reproducible positions, trajectories and dynamics can thus be deposited on a bearing surface that is always identically positioned, with only the spring-like action of a stack of greater or lesser height being able to change with the stack height. Sensor-based height detection of the stack is therefore advantageous in order to always be able to deposit an element on the stack in the same plane.

According to one embodiment, the device furthermore has a recording unit, which is designed to record operating parameters that are associated with a stacking of the electrode elements in the receiving unit, in particular a height check for tracking the depositing base and/or a measurement of the outer geometry of the stack from the top or bottom.

Such operating parameters can include, by way of example, a present stack height, a stack mass, a measure of the positional accuracy of individual electrode elements in the receiving unit, a spacing between the stacking wheel and the base structure, a rotational speed of the stacking wheel, or a combination of these parameters. Following recording, these parameters can be delivered to a controller, a drive unit and/or a user interface.

According to one embodiment, the recording unit is designed to record the operating parameters on the basis of optical or camera-based measuring methods.

This can permit an optical or camera-based height check and automatic control of the base structure so as therefore to adapt the base structure, as outlined above, for the respective present stack height.

According to one embodiment, the device furthermore has a drive unit, which is designed to displace the base structure with respect to the stacking wheel on the basis of the recorded operating parameters.

The drive unit may therefore be an active means for moving the base structure, there being able to be provision for a motor-driven movement mechanism or guidance mechanism, which actively displaces or moves the base structure of the receiving unit.

According to one embodiment, the base structure of the receiving unit is angled with respect to a horizontal bearing plane of the device. In particular, the base structure of the receiving unit is angled with respect to the horizontal bearing plane of the device while the electrode elements are being deposited on the electrode stack, with the result that the delimiting element is situated in a region of a highest point of the base structure. By way of example, the base structure of the receiving unit remains angled with respect to the horizontal bearing plane of the device permanently or at least until the electrode stack is completely formed.

The horizontal bearing plane of the device may be defined by an installation surface of the device that is used to install the device in an operating environment. The installation surface can therefore be positioned on a floor area of the operating environment.

The base structure of the receiving unit may therefore be angled with respect to the horizontal bearing plane or installation surface of the device, with the result that a surface normal of the flat electrode elements stacked onto the base structure is angled with respect to a direction of gravity. By way of example, the surface normals of the flat electrode elements stacked onto the base structure and the direction of gravity form an acute angle. The base structure may thus be tilted with respect to the floor area of the operating environment, with the result that the delimiting element aligned statically in relation to the stacking wheel axis and/or the base structure is arranged in the region of the highest point of the base structure. This alignment of the base structure and the delimiting element can lead to a further improvement in the sequence of movements of the individual electrode elements while being deposited on the electrode stack.

The angled arrangement of the base structure leads to the electrode elements that are already deposited on the electrode stack experiencing a force component in the direction of the end stop or wiper situated opposite the delimiting element, due to their gravity. This can help to prevent the electrode elements that are already situated on the electrode stack, or the topmost one, from slipping when the next electrode element is deposited thereon from above. This allows the alignment of the electrode elements to be additionally improved.

According to one aspect, a method for producing an electrode stack containing flat electrode elements is specified. The method can be carried out e.g. using the device described above. In one step of the method, a first electrode element is provided. In a further step, the first electrode element is introduced into an intermediate space which is formed by stacking wheel fingers of a stacking wheel rotating about a stacking wheel axis or axis of rotation. In a further step, the first electrode element is transported using the stacking wheel. In a further step, the first electrode element is removed from the intermediate space. In a further step, the first electrode element is fed into a receiving unit. In a further step, a movement of the first electrode element is delimited by means of a delimiting element after said first electrode element has been fed into the receiving unit. In a further step, a second electrode element is provided. In a further step, the second electrode element is introduced into a further intermediate space, different from the intermediate space, which is formed by stacking wheel fingers of the stacking wheel. In a further step, the second electrode element is removed from the further intermediate space. In a further step, the second electrode element is fed into the receiving unit so as therefore to produce an electrode stack, which is formed on a base structure of the receiving unit. In a further step, a movement of the second electrode element is delimited by means of the delimiting element after said second electrode element has been fed into the receiving unit. The delimiting element is arranged statically in relation to the base structure and therefore forms an end stop for the first and second electrode elements fed into the receiving unit. In one example, the individual method steps can be carried out in the order indicated.

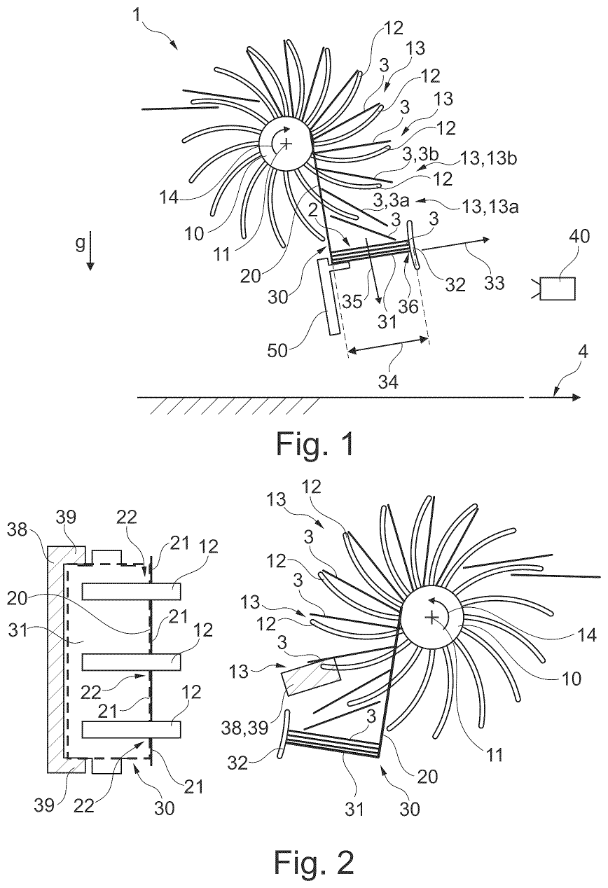

FIG. 1 shows a device for producing an electrode stack containing flat electrode elements.

FIG. 2 shows a plan view and a cross-sectional view of a device for producing an electrode stack containing flat electrode elements.

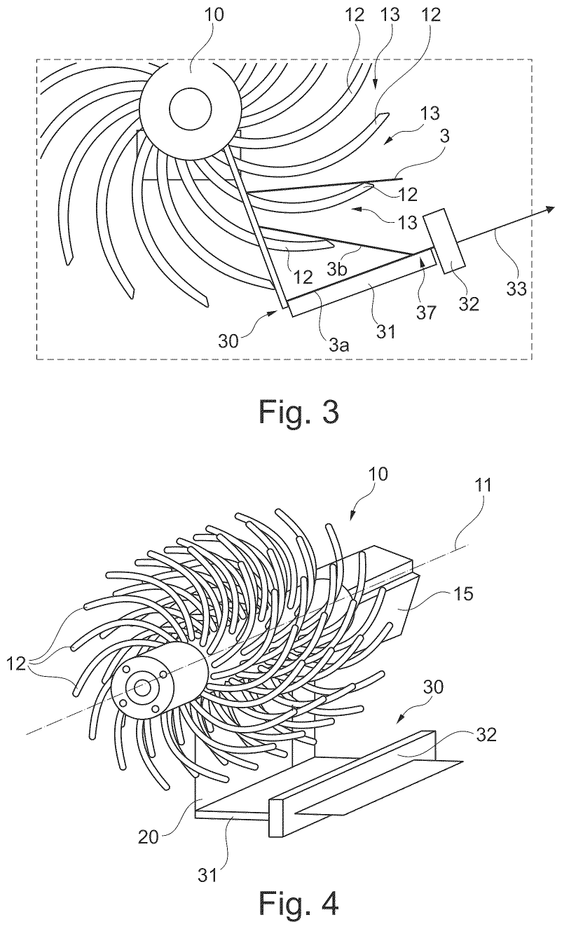

FIG. 3 shows a detail view of a receiving unit of a device for producing an electrode stack containing flat electrode elements.

FIG. 4 shows a perspective view of a device for producing an electrode stack containing flat electrode elements.

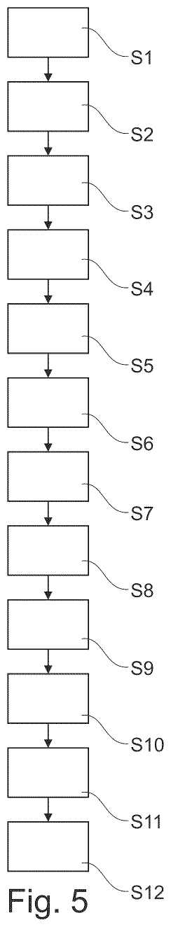

FIG. 5 shows a flowchart for a method for producing an electrode stack containing flat electrode elements.

The depictions in the figures are schematic and not to scale. Where the same reference signs are used in different figures in the description of the figures that follows, these denote identical or similar elements. Identical or similar elements may also be denoted by different reference signs, however.

FIG. 1 shows a device 1 for producing an electrode stack 2 containing flat electrode elements 3, this being a cross-sectional view or side view of the device 1, for example. The device 1 has a stacking wheel 10, which is mounted to rotate about a stacking wheel axis 11 and comprises a plurality of stacking wheel fingers 12, which define respective intermediate spaces 13 for receiving the electrode elements 3. In the depiction shown in FIG. 1, some of the plurality of stacking wheel fingers 12 and some of the intermediate spaces 13 and the electrode elements 3 situated therein are identified by reference signs. As can be seen, the stacking wheel fingers 12 stretch substantially radially in relation to the stacking wheel axis 11 and may be slightly arcuate.

In this example, the stacking wheel 10 performs a rotational movement 14 in a clockwise direction in order to convey the individual electrode elements 3 from a feed unit (not shown) to a receiving unit 30. A wiper unit 20 interacts with the rotational movement 14 of the stacking wheel 10 in such a way that the electrode elements 3 are removed one after the other from the respective intermediate spaces 13 and subsequently conveyed into the receiving unit 30 according to a specific sequence of movements. The receiving unit 30 has a base structure 31, which comprises a base surface or other base elements, for example, so that the electrode elements 3 can be stacked on the base structure 31. The base structure 31 defines a receiving expanse 34 or a receiving dimension 34, which extends parallel to a direction 33 arranged perpendicular to the stacking wheel axis 11. The direction 33 can have a tangential alignment in relation to the rotational movement 14 of the stacking wheel 10. The receiving expanse 34 may be delimited in the direction 33, that is to say toward the outside, by a delimiting element 32, which forms an end stop for the electrode elements 3 received in the receiving unit 30 and which is arranged statically in relation to the stacking wheel axis 11.

The delimiting element 32 is shown curved in the schematic representation of FIG. 1. In an embodiment that is not shown, the delimiting element 32 may also be straight, however.

The delimiting element 32 can form the end stop for the electrode elements 3 received in the receiving unit 30 in such a way that the electrode elements 3 that have already been stacked in the receiving unit 30 are prevented from moving in the direction 33 so as therefore to allow the electrode elements 3 to be stacked in alignment, as shown in FIG. 1. In other words, this means that the electrode elements 3 stacked in the receiving unit 30 are prevented from moving in the direction 33 tangential to the rotational movement 14 of the stacking wheel 10. The position and/or alignment of the delimiting element 32 relative to a position and/or alignment of the rotational axis 11 and/or the base structure 31 may be fixed and thus invariable, with the result that the receiving expanse 34 defined by the axis of rotation 11 and/or the base structure 31 is invariable in its reach in the direction 33.

The device 1 can furthermore comprise a recording unit 40, which is designed to record operating parameters that are associated with a stacking of the electrode elements 3 in the receiving unit 30. The recording unit 40 can comprise a camera and/or optical measuring instruments in order to permit visual or optical recording of the operating parameters. The camera or the sensor is preferably arranged above, i.e. with a plan view of, the stacking of the electrode elements 3, in order to the result of depositing the last electrode element.

The device 1 can furthermore comprise a drive unit 50, which is designed to move, in particular to displace, the base structure 31 with respect to the stacking wheel 10 on the basis of the recorded operating parameters. The drive unit 50 may be formed by a motor-driven movement mechanism, which can displace the base structure 31 along the direction of displacement 35 together with the delimiting element 32 or separately from the delimiting element 32. The direction of displacement 35 may be aligned in relation to the stacking wheel 10 in such a way that the base structure 31 moves away from the stacking wheel 10 or the stacking wheel axis 11 while the individual electrode elements 3 are being received one after the other in the receiving unit 30 and stacked there.

FIG. 1 shows a state in which there are currently three electrode elements 3 in the stack 2 and a fourth electrode element 3 is being removed from an intermediate space 13 and received in the receiving unit 30. This electrode element 3 being removed from the intermediate space 13 is pushed out of the applicable intermediate space 13 by the wiper unit 20 and therefore arrives in the receiving unit 30 and on the electrode stack 2. Whenever an electrode element 3 is fed onto the electrode stack 2, the base structure 31 can continue to be displaced with respect to the stacking wheel 10 along the direction of displacement 35 in discrete steps or continuously. This displacement, which is carried out actively, for example, by the drive unit 50, can take place on the basis of a present stack height and/or a present mass of electrode elements 3 in the receiving unit 30 or in the electrode stack 2.

The stacking wheel 10, the wiper unit 20 and the receiving unit 30 may be arranged in relation to one another in such a way that the electrode elements 3, when removed from the intermediate spaces 13 and when received in the receiving unit 30, follow the sequence of movements already mentioned above. The base structure 31 can in particular be displaced with respect to the stacking wheel 10 in such a way that said sequence of movements is identical for every electrode element 3 received in the receiving unit 30. This can be achieved for example as a result of the base structure 31 being displaced with respect to the stacking wheel 10 such that a spacing between the stacking wheel axis 11 and a respective electrode element 3 most recently stacked in the receiving unit 30 is constant. In other words, the distance that an electrode element 3 needs to cover between the respective intermediate space 13 and the currently topmost electrode element 3 in the electrode stack 2 in order to get from the intermediate space 13 to the electrode stack 2 is identical for each of the successive electrode elements 3 introduced into the receiving unit 30.

Another advantageous embodiment provides for height detection, which ensures that the stack level is identical for every electrode element that is currently to be stacked. Although constant lowering of the depositing base or the base structure 31 per electrode element is possible, height detection takes into account the compression of the stack by the weight force of the electrode elements, i.e. the travel per electrode element when the first electrode element is put on the base structure 31 is rather high. The more electrode elements are stacked, the shorter the travel, since the intermediate spaces between the electrode elements, which are not ideally smooth, at the bottom of the stack are reduced as a result of the weight force, i.e. the electrode stack is compressed.

The base structure 31 of the receiving unit 30 may, as shown in FIG. 1, be angled with respect to a horizontal bearing plane 4 of the device 1, with the result that the delimiting element 32 is situated in a region of a highest point 36 of the base structure 31. In other words, the base structure 31 may be arranged in a manner slightly tilted with respect to the bearing plane 4, with the result that a surface normal of the already stacked electrode elements 3 and/or the aforementioned direction of displacement 35 is angled with respect to a direction of gravity g when the device 1 is used in an operating environment as intended.

FIG. 2 shows a plan view and a cross-sectional view of a device 1 for producing an electrode stack 2 containing flat electrode elements 3. This may be the device 1 from FIG. 1, for example. The left-hand depiction shows the plan view and the right-hand depiction shows the cross-sectional view of the device 1. In the plan view shown on the left, it can be seen that a series of stacking wheel fingers 12 of the stacking wheel 10 comprises three stacking wheel fingers 12, the right-hand cross-sectional view revealing that such a series of stacking wheel fingers 12 separates two respective adjacent intermediate spaces 13 from one another.

Looking at the depictions, FIG. 2 also reveals that the wiper unit 20 has multiple wall elements 21, which are separated in the region of the stacking wheel fingers 12 by cutouts 22, through each of which one of the stacking wheel fingers 12 sweeps. The effect of this is that an electrode element 3 covering the width of a series of stacking wheel fingers 12 can be conveyed evenly out of the applicable intermediate space 13 when touching the wiper unit 20. In other words, as soon as the stacking wheel 10 is rotated far enough and the electrode element 3 has thus reached the wiper unit 20, the electrode element 3 is moved out of the intermediate space 13 by further rotation of the stacking wheel 10. It will be understood that the right-hand depiction in FIG. 2 shows the stacking wheel 10 with a direction of rotation 14 anticlockwise about the stacking wheel axis 11, and so the depiction shown on the right in FIG. 2 is reversed compared to the depiction in FIG. 1.

Both depictions in FIG. 2 also show a lateral delimiting unit 38, which can guide the electrode elements 3 laterally while they are moving out of the applicable intermediate space 13. To this end, the lateral delimiting unit 38 can have two lateral delimiting elements 39, which guide the electrode elements 3 according to a lateral desired movement or convey them into a lateral desired position in the receiving unit 30. Similarly, the base structure 31 of the receiving unit 30, on which the electrode elements 3 are stacked to form the electrode stack 2, can be seen in both depictions.

The lateral delimiting unit 38 and/or the lateral delimiting elements 39 may also be arranged further away from the base structure 31, that is to say further upward in the image plane than shown schematically in FIG. 2, in order to correct the position of the elements. As soon as the edge of the element touches the wiper unit 20, the clamping in the stacking wheel 10 is cancelled, and from then onward the lateral delimiting unit 38 and/or the lateral delimiting elements 39 can effectively intervene.

FIG. 3 shows a detail view of the receiving unit 30 of the device 1 from FIGS. 1 and 2. It is again possible to see the stacking wheel 10 with multiple stacking wheel fingers 12, which each define the intermediate spaces 13 for conveying the electrode elements 3.

In one embodiment, which is not shown further, the wiper unit 20 or rear wall of the receiving unit 30 may be fitted such that it leads through the stacking wheel axis 11. As such, simple alteration of the angle of the depositing base 31 compared to the horizontal plane is possible. By way of example, this alteration leads to not only the spacing of the base structure 31 from the stacking wheel 10 but also the angle of incidence of an electrode element on the depositing base 31 being able to be adjusted. The adjustable angle of incidence and/or point of incidence leads to an ideal setting between normal and tangential forces on the electrode element being able to be adjusted for optimum stack formation.

FIG. 3 shows a state or time in/at which a first electrode element 3a is already on the base structure 31 of the receiving unit 30. The first electrode element 3a may be in contact with the delimiting element 32 and thereby be prevented from moving further in the direction 33.

Furthermore, at the time shown, a second electrode element 3b is being conveyed out of one of the intermediate spaces 13 and fed into the receiving unit 30. At this time, for example one edge of the second electrode element 3b hits the first electrode element 3a, which is already in the receiving unit 30, leading, at a point of impact 37, to a force or an impulse that presses or pushes the first electrode element 3 toward the delimiting element 32. Since the first electrode element 3a is already in contact with the delimiting element 32, however, this contact between the two electrode elements 3a, 3b does not lead to the first electrode element 3a slipping. As this applies equally to every further electrode element 3 fed into the receiving unit 30, aligned stacking of the electrode elements 3 can be promoted.

FIG. 4 shows a perspective view of the device 1 described in the preceding figures. It is again possible to see the stacking wheel fingers 12 of the stacking wheel 10 rotating about the stacking wheel axis or axis of rotation 11. The stacking wheel 10 can be driven by a stacking wheel motor 15. It is also possible to see the wiper unit 20 and the receiving device 30 with the delimiting element 32 arranged statically in relation to the stacking wheel axis 11. The delimiting element 32 may be mounted directly on the base structure 31. However, it is also possible for the delimiting element 32 not to be mounted directly on the base structure 31, but rather for the two components merely to be positioned and/or aligned, for example statically, in relation to one another.

FIG. 5 shows a flowchart for a method for producing an electrode stack containing flat electrode elements. The method can be performed for example by the device 1 described with reference to FIGS. 1 to 4, to which reference is also made hereby. In a step S1 of the method, a first electrode element 3a is provided. In a further step S2, the first electrode element 3a is introduced into an intermediate space 13a which is formed by stacking wheel fingers 12 of a stacking wheel 10 rotating about a stacking wheel axis or axis of rotation 11. In a further step S3, the first electrode element 3a is transported using the stacking wheel 10. In a further step S4, the first electrode element 3a is removed from the intermediate space 13a (cf. also state in FIG. 1). In a further step S5, the first electrode element 3a is fed into a receiving unit 30. In a further step S6, a movement of the first electrode element 3a is delimited by means of a delimiting element 32 after said first electrode element has been fed into the receiving unit 30. In a further step S7, a second electrode element 3b is provided. In a further step S8, the second electrode element 3b is introduced into a further intermediate space 13b, different from the intermediate space 13a, which is formed by stacking wheel fingers 12 of the stacking wheel 10. In a further step S9, the second electrode element 3b is transported using the stacking wheel 10. In a further step S10, the second electrode element 3b is removed from the further intermediate space 13b (cf. likewise state in FIG. 1). In a further step S11, the second electrode element 3b is fed into the receiving unit 30 so as therefore to produce an electrode stack 2, which is formed on a base structure 31 of the receiving unit 30. In a further step S12, a movement of the second electrode element 3b is delimited by means of the delimiting element 32 after said second electrode element has been fed into the receiving unit 30.

The delimiting element 32 may be arranged statically in relation to the stacking wheel axis or axis of rotation 11 or the base structure 31.

The delimiting element 32 may also be movable to the outside, for example in order to permit depositing in a staircase-shaped manner for partially arcuate elements. It can therefore form an end stop for the first and second electrode elements 3a, 3b fed into the receiving unit 30.

1.-15. (canceled)

16. A device for producing an electrode stack containing flat electrode elements, comprising:
a stacking wheel, which is mounted to rotate about a stacking wheel axis and has a plurality of stacking wheel fingers, which define respective intermediate spaces for receiving the electrode elements;
a wiper unit, which is designed to remove the electrode elements one after the other from the respective intermediate spaces through interaction with a rotational movement of the stacking wheel about the stacking wheel axis;
a receiving unit, which is designed to successively receive the electrode elements removed from the intermediate spaces;
wherein the receiving unit comprises a base structure, on which the electrode elements received in the receiving unit can be stacked;
wherein the receiving unit furthermore comprises a delimiting element, which forms an end stop for the electrode elements received in the receiving unit and which is arranged statically in relation to the stacking wheel axis.

17. The device as claimed in claim 16, wherein the delimiting element forms the end stop for the electrode elements received in the receiving unit in such a way that the electrode elements received in the receiving unit are prevented from moving in at least one direction so as therefore to permit the electrode elements to be stacked in alignment.

18. The device as claimed in claim 16, wherein the delimiting element is arranged statically in relation to the stacking wheel axis in such a way that electrode elements stacked in the receiving unit are prevented from moving in a direction tangential to the rotational movement of the stacking wheel.

19. The device as claimed in claim 16, wherein a position of the delimiting element relative to a position of the base structure is fixed, with the result that a receiving expanse defined by the base structure is invariable.

20. The device as claimed in claim 19, wherein the receiving expanse defined by the base structure extends parallel to a direction arranged perpendicular to the stacking wheel axis.

21. The device as claimed in claim 16, wherein the base structure is arranged displaceably with respect to the stacking wheel.

22. The device as claimed in claim 16, wherein the base structure is displaceable with respect to the stacking wheel on the basis of a present stack height and/or a present mass of electrode elements in the receiving unit.

23. The device as claimed in claim 16, wherein the base structure is displaceable with respect to the stacking wheel along a direction of displacement extending along or parallel to a radial direction of the stacking wheel.

24. The device as claimed in claim 16, wherein the stacking wheel, the wiper unit and the receiving unit are arranged in relation to one another in such a way that the electrode elements follow a specific sequence of movements when being removed from the intermediate spaces and when being received in the receiving unit;
wherein the base structure is displaceable with respect to the stacking wheel in such a way that the sequence of movements is identical for every electrode element received in the receiving unit.

25. The device as claimed in claim 16, wherein the base structure is arranged displaceably with respect to the stacking wheel in such a way that a spacing between the stacking wheel axis and a respective electrode element most recently received in the receiving unit is constant.

26. The device as claimed in claim 16, furthermore comprising:
a recording unit, which is designed to record operating parameters that are associated with a stacking of the electrode elements in the receiving unit.

27. The device as claimed in claim 26, wherein the recording unit is designed to record the operating parameters on the basis of optical or camera-based measuring methods.

28. The device as claimed in claim 26, furthermore comprising:
a drive unit, which is designed to displace the base structure with respect to the stacking wheel on the basis of the recorded operating parameters.

29. The device as claimed in claim 16, wherein the base structure of the receiving unit is angled with respect to a horizontal bearing plane of the device, with the result that the delimiting element is situated in a region of a highest point of the base structure.

30. A method for producing an electrode stack containing flat electrode elements, comprising:
providing a first electrode element;
introducing the first electrode element into an intermediate space which is formed by stacking wheel fingers of a stacking wheel rotating about an axis of rotation;
transporting the first electrode element using the stacking wheel;
removing the first electrode element from the intermediate space;
feeding the first electrode element into a receiving unit;
delimiting a movement of the first electrode element by means of a delimiting element after said first electrode element has been fed into the receiving unit;
providing a second electrode element;
introducing the second electrode element into a further intermediate space, different from the intermediate space, which is formed by stacking wheel fingers of the stacking wheel;
transporting the second electrode element using the stacking wheel;
removing the second electrode element from the further intermediate space;
feeding the second electrode element into the receiving unit so as therefore to produce an electrode stack, which is formed on a base structure of the receiving unit;
delimiting a movement of the second electrode element by means of the delimiting element after said second electrode element has been fed into the receiving unit;
wherein the delimiting element is arranged statically in relation to the axis of rotation and therefore forms an end stop for the first and second electrode elements fed into the receiving unit.
